(19) United States
(12) Patent Application Publication
(10) Pub. No.: US 2024/0324528 A1
(43) Pub. Date: Oct. 3, 2024

(54) IRRIGATION MANAGEMENT SYSTEM FOR NUTRICULTURE OF CROPS

(71) Applicant: IREIS CO., LTD., Gangneung (KR)

(72) Inventors: Chang Mok LIM, Gangneung (KR); Chong Won KWAK, Seoul (KR); Young Ji LEE, Anyang-si (KR)

(73) Assignee: IREIS CO., LTD., Gangneung (KR)

(21) Appl. No.: 18/684,642

(22) PCT Filed: Feb. 10, 2023
(86) PCT No.: PCT/KR2023/001947

§ 371 Date: May 14, 2024

(30) Foreign Application Priority Data
Feb. 2, 2023 (KR) 10-2023-0014340

(51) Int. Cl. A01G 25/16; A01C 23/04

(52) U.S. Cl. CPC A01G 25/167; A01C 23/042

(57) ABSTRACT

An irrigation management system for nutriculture of the crops comprises media medium, a weight sensor, a nutrient solution unit and a server, and the weight sensor measures the weight of the medium and transmits weight value to the server; the server calculates moisture weight content ratio based on the weight value, generates a control signal based on the moisture weight content ratio, and transmits the control signal to the nutrient solution unit; the nutrient solution unit controls irrigation to the medium based on the control signal, the weight value is measured at respective starting and ending point in the plurality of periods dividing 24 hours by the pre-determined criteria, the plurality of periods have include a moisture weight content ratio and each moisture weight content ratio is derived according to the formula of Ww=(Wo−W)/W*100.

### TECHNICAL FIELD

The present invention relates to an irrigation management system used for nutriculture of crops, particularly for the irrigation management system based on the moisture weight content ratio.

### BACKGROUND

The aquaculture can produce various crops while having the least impact from weather and climate. Owing to these advantages, the aquaculture draws high attention as a sector of future oriented agricultural technologies.

Out of these, the medium contains nutrient solution made by mixing water and nutritional ingredients in variety. The nutrient solution is supplied to the medium regularly. The types and supplying amount of nutrient solution may be differed depending on type of crops. On the other hand, the nutrient solution may be supplied differently depending on the stage of growth like germinating period, pre-growth period, transplanting period, seedling period and mitotic period in spite of the crops under same nutrient solution.

The traditional nutrient solution supply is dependent on fixed time without considering type and growth stages of the crops. This method results in wasting the nutrient solution without supplying most appropriate amount for the type and growth stage of the corresponding crop.

### SUMMARY

It is to offer the irrigation management system adjusting the nutrient solution effectively depending on type and growth stage of the crops.

The irrigation management system for nutriculture of the crops comprises a medium, a weight sensor, a nutrient solution unit and a server, and the weight sensor measures weight of the medium and transmits weight value to the server; the server calculates moisture weight content ratio based on the weight value, generates a control signal based on the moisture weight content ratio, and transmits the control signal to the nutrient solution unit; the nutrient solution unit controls irrigation to the medium based on the control signal, the weight value is measured at respective starting and ending point in the plurality of periods dividing 24 hours by the pre-determined criteria, and the plurality of periods respectively have a moisture weight content ratio and each moisture weight content ratio is derived according to the following [Mathematical formula 1].

$$Ww = ( Wo - W ) / W * 100 \qquad [ Mathematical formula 1 ]$$

(Ww: Moisture weight content ratio, Wo: Weight at ending point of each period, W: Weight at starting point of each period)

The plurality of periods include first period to fourth period, the starting point of the first period is sunrise time, the ending point is the first irrigation time, the critical range is between-2% and 1%, the starting point of the second period is the first irrigation time, the ending point is the final irrigation time, the critical range is between 6% and 8%, the starting point of the third period is the final irrigation time, the ending point is sunset time, critical range is between-4% and 3%, the starting point of the fourth period is sunset time, the ending point is sunrise time and critical range is between-3% and 2%,

The control signal includes irrigation increment signal, when the moisture weight content ratio of each period is less than critical range of each period, the control signal includes irrigation decrement signal, when the moisture weight content ratio is more than critical range, the nutrient solution unit either increases the amount of irrigation to the medium or shortens the irrigation cycle when the control signal includes the irrigation increment signal, and the nutrient solution unit either decreases the amount of irrigation to the medium or extends the irrigation cycle when the control signal includes the irrigation decrement signal.

The irrigation management system for nutriculture of the crops comprises a medium, a weight sensor and a nutrient solution unit, and the weight sensor measures weight of the medium and transmits weight value to the nutrient solution unit; the nutrient solution unit calculates moisture weight content ratio, and generates a control signal based on the moisture weight content ratio and controls the irrigation to the medium based on the control signal, the weight value is measured at respective starting and ending point in the plurality of periods dividing 24 hours by the pre-determined criteria, the plurality of periods respectively have a moisture weight content ratio and each moisture weight content ratio is derived according to the following [Mathematical formula 2].

$$Ww = ( Wo - W ) / W * 100 \qquad [ Mathematical formula 2 ]$$

(Ww: Moisture weight content ratio, Wo: Weight at ending point of each period, W: Weight at starting point of each period)

The plurality of periods include first period to fourth period, the starting point of the first period is sunrise time, the ending point is the first irrigation time, the critical range is between-2% and 1%, the starting point of the second period is the first irrigation time, the ending point is the final irrigation time, the critical range is between 6% and 8%, the starting point of the third period is the final irrigation time, the ending point is sunset time, critical range is between-4% and 3%, the starting point of the fourth period is sunset time, the ending point is sunrise time and critical range is between-3% and 2%.

The control signal includes the irrigation increment signal, when the moisture weight content ratio of each period is less than critical range of each period, the control signal includes irrigation decrement signal, when the moisture weight content ratio is more than critical range, the nutrient solution unit either increases the amount of irrigation to the medium or shortens irrigation cycle, when the control signal includes the irrigation increment signal, and the nutrient solution unit either decreases the irrigation amount to the medium or extends the irrigation cycle, when the control signal includes the irrigation decrement signal.

This system can adjust the amount of nutrient solution depending on types and growth stage of the crops.

### BRIEF DESCRIPTION OF THE DRAWINGS

FIG. 1 depicts the supply and drainage to the medium, changes on weight of the medium.

### DETAILED DESCRIPTION

Hereafter, the exemplary embodiments are described in detail by referring to the drawings attached. The same reference numbers shown on the drawing represent same sub-material.

The embodiments described hereafter may be changed in variety. The following embodiments do not limit the performing patterns, but they should be understood to include overall changes, equivalents or alternatives.

The terminologies used in the embodiments were used simply to describe specific embodiment not intended to restrict the embodiment. The singular expressions include the plurality of unless otherwise distinctively mean differently in context. The terminologies of “include” or “comprise” herein are to designate the existence of feature, figure, step, motion, component, part or its assemblies described in the statement, and they should be understood not to exclude the possibility of existence or addition of single or more other feature, figure, step, motion, component, part or its assemblies.

Unless otherwise defined, overall terminologies used herein including technological or scientific terminologies include the same meaning with general understanding by the people who include usual knowledge on the technology fields related to the embodiments. The terminologies defined in the dictionaries for general use should be understood as having same meaning with the meaning of related technological context. Unless defined clearly in this application, it shall not be interpreted as idealistic or excessively formative meaning.

In addition, in describing by referring to the drawings attached, same reference number is given to same component regardless of the No. of drawings, and the overlapped description on this number shall be omitted. In describing the embodiments, the specific descriptions shall be skipped when specific descriptions on the related technologies known public are likely to obscure the key point of the embodiment.

Usually, the crops grown in farming house are classified into the ground-zone and root-zone. The ground-zone and root-zone have independent aspect in a side, on the other side, they have relativeness. The root-zone plays instrumental role in growth of the plant because it functions for absorbing required nutritional sources for the growth. However, it is very hard to acquire the data to validate the epidemiological relation between physiological soundness, and cultivating environment on the root-zone of specific crop is different entirely depending on its type.

The state of the root-zone is one of important information embedded in the medium. The state of root-zone of the medium makes the biggest impact on the growth of root. Root management is important like maintaining the moisture content ratio around the root inside the medium in order to enhance the merchantability and yield ratio of the crops.

Here, moisture content ratio can be calculated based on the weight value measured with weight sensor. Such derived moisture content ratio is called as moisture weight content ratio in this application.

A load cell can be used for the weight sensor, but this application does not describe its specific operation mechanism because it is a prior art.

A variety of information can be obtained like medium weight of the root-part, the amount of irrigation, the amount of drainage, temperature, humidity, electric conductivity (EC), pH (Acidity), medium temperature and weight by installing many sensors at a side of the medium. The information may be measured in real time, and various parameters can be adjusted based on the measured data like temperature and nutritional ingredients included in the medium. Moreover, the external growing environment can be measured within minimized error/mistake like weather, temperature and humidity at the same time.

Differentiated data on the root-part and external growth environment can be measured via the sensors in variety. Such measured data are used for controlling smart farm like nutrient solution measuring of irrigation and drainage. The irrigation management system is effective when used for medium based facility plantation particularly for paprika and tomato.

All data measured at the farm are saved into wire or wireless connected local storage or independently operated cloud server. The saved data can be used in finding the optimal temperature deviation and temperature control program through analyzing temperature difference data between day and night and the growth results in the farm. In addition, the farming house can use the easily seen graph for daily/weekly/monthly data directly to the farming.

On the other hand, the irrigation management system can control additionally for setting the irrigation time, irrigation in each section and optical amount control when the nutrient solution management algorithm is used. In addition, the irrigation management system can set additionally the electric conductivity (EC), pH, range of electric conductivity and pH in each section.

For the system realized in separate type of nutrient solution unit and server, the nutrient solution management algorithm can be operated by server. The nutrient solution management algorithm can be run by nutrient solution unit when the system is realized with nutrient solution unit and server in all-in-one.

The irrigation management system can perform irrigation and/or drainage automatically by delivering the command to the external device based on the moisture weight content ratio when the irrigation management system is connected to external device via communication terminal. In other words, the external device may include the unit for controlling the irrigation and/or drainage.

According to the embodiment of the present invention, the medium is formed in lengthy rectangular parallelepiped in general. Nutrient solution discharging hole is made at the bottom of the medium for emitting the excessive solution when the solution is extremely supplied to the medium. The excessive nutrient solution discharged from the outlet is stored at the nutrient solution collection container.

The nutrient solution is essential element for the growth of the plant. Most of the farming houses tend to supply the nutrient solution excessively for active growth of the crops regardless of the changes on the internal conditions in the greenhouse. It increases the manufacturing cost for wasting large amount of the nutrient solution and results in contaminating the soil, ground water and river due to scrapped nutrient solution. The ground water can be saved for producing nutrient solution and cost reduction effect can be expected when the nutrient solution is recycled.

The irrigation management system according to an embodiment comprises a medium, a weight sensor, a nutrient solution unit and a server.

The weight sensor measures weight of the medium and transmits weight value to the server.

The server calculates moisture weight content ratio based on the weight value, generates a control signal based on the moisture weight content ratio and transmits the control signal to the nutrient solution unit.

The moisture weight content ratio can be calculated according to the following [Mathematical formula 1].

$$Ww = ( Wo - W ) / W * 100 \qquad [ Mathematical formula 1 ]$$

(Wo: Weight at ending point of each period, W: Weight at starting point of each period)

The nutrient solution unit controls the irrigation to the medium based on the control signal.

The weight value is measured at respective starting and ending point in the plurality of periods dividing 24 hours by the pre-determined criteria.

The plurality of periods include first period to fourth period, the starting point of the first period is sunrise time, the ending point is the first irrigation time, and the critical range may be between-2% and 1%.

In one example, the first irrigation may be performed at the pre-determined time.

In another example, the first irrigation time may mean the time of reduction the moisture weight content ratio by pre-determined amount (For example, 1%, 2% and 3%) compared to the sunrise.

The starting point of the second period is the first irrigation time, the ending point is the final irrigation time and the critical range is between 6% and 8%.

In one example, whether or not it is the final irrigation can be determined by the pre-determined value on the nutrient solution unit or server. For example, the nutrient solution unit and/or server accumulates the number of time at every irrigation, but when cumulative value is same with the pre-determined number of irrigation the irrigation creating the cumulative value can recognize as a final irrigation.

The starting point of the third period is the final irrigation time, the ending point is sunset time and the critical range may be between −4% and 3%.

The starting point of the fourth period is sunset time and the ending point is sunrise time and critical range may be between −3% and 2%.

The nutrient solution unit can adjust moisture weight content ratio within the critical range by a variety of means when the moisture weight content ratio more than or less than the critical range.

The nutrient solution unit operates according to the control signal which can be set as follows.

The control signal may include the irrigation increment signal when the moisture weight content ratio of each period is less than the critical range of each period.

The control signal may include the irrigation decrement signal when the moisture weight content ratio of each period is more than the critical range of each period.

The nutrient solution unit may increase the amount of irrigation or shorten the irrigation cycle to the medium when the control signal includes the irrigation increment signal.

The nutrient solution unit may decrease the amount of irrigation or extend the irrigation cycle to the medium when the control signal includes the irrigation decrement signal.

In the above adjustment process, the moisture weight content ratio can be adjusted to be an arbitrary specific value within the critical range.

In one embodiment, the moisture weight content ratio can be adjusted to become a median of critical range. For example, the moisture weight content ratio can be adjusted to become a median of the critical range, −0.5%, after deviating the critical range when the critical range of first period is in between −2% and 1%. The distance from the median to the both ends of the critical range is equivalent. Therefore, the likelihood of re-deviating of the moisture weight content ratio out of the critical range can be reduced when the change amount of moisture weight content ratio to the direction of more than or less than the critical range is not relatively big.

In another embodiment, the moisture weight content ratio can be adjusted to be closest value to the critical range. For example, the moisture weight content ratio can be adjusted to be 1% which is the closest to the 2% of critical range when the critical range is between −2% and 1% in first period and the current moisture weight content ratio is 2%. Thereby, time for adjusting the moisture weight content ratio is spent less than other ways because the moisture weight content ratio can be maintained not to deviate from the critical range with the least change on the moisture weight content ratio.

In another embodiment, the moisture weight content ratio can be set to be adjusted towards the critical range by the pre-determined value based on the closest value out of the critical range. At this time, the pre-determined value is smaller than the length of critical range.

For example, the pre-determined value is smaller than 3% because the critical range in the first period is between −2% and 1%.

The moisture weight content ratio can be set to be 0.5% by adjusting towards the critical range by 0.5% from the closest value, 1%, of the critical range of the first period when the critical range of first period is between −2% and 1%, current moisture weight content ratio is 2% and pre-determined value is 0.5%. This method can reduce arithmetic load on the system because the moisture weight content ratio can be adjusted without calculating the moisture weight content ratio deviation level from the critical range by determining the range of fluctuation of moisture weight content ratio as the pre-determined value.

In another embodiment, the moisture weight content ratio can be adjusted to be farthest value within the critical range. For example, the moisture weight content ratio can be adjusted to −2% farthest from the moisture weight content ratio, 2%, within the critical range of moisture weight content ratio when the critical range is between-2% and 1% in first period and the current moisture weight content ratio is 2%.

This method can be chosen based on the fluctuation pattern of the moisture weight content ratio analyzed by the server.

The fluctuation pattern can be analyzed by following algorithms in variety.

For example, the server may analyze the fluctuation pattern on the moisture weight content ratio as “increment” when moisture weight content ratio increases more than the pre-determined times (For example, 7 times) during the pre-determined monitoring time (For example, 1 hour). The server can adjust the moisture weight content ratio to be the farthest value within the critical range from the moisture weight content ratio when the moisture weight content ratio exceeds the critical range within the pre-determined pattern applicable time (For example, 30 minutes) from the resulting time of the analysis.

For the opposing case of above described one, the fluctuation pattern on the moisture weight content ratio can be analyzed as “decrement.”

The fluctuation pattern analysis can be performed by the nutrient solution unit when the nutrient solution unit and the server are realized in all-in-one type.

This method can prevent the moisture weight content ratio from deviating the critical range again for relatively long time after adjusting the moisture weight content ratio than other methods through reflecting the direction of moisture weight content ratio change to adjusting the moisture weight content ratio.

In opposing case of the embodiment, the moisture weight content ratio can be adjusted to be farthest value, 1%, from moisture weight content ratio, −3%, of the critical range when the critical range is between −2% and 1% in first period and the current moisture weight content ratio is −3%.

In another embodiment, the moisture weight content ratio can be set to be adjusted towards the critical range by the pre-determined value based on the farthest value out of the critical range. For example, the moisture weight content ratio can be set to be −1% by adjusting towards to critical range by 1% from the farthest critical range, −2%, when the critical range is between −2% and 1% in first period, the current moisture weight content ratio is 2% and pre-determined value is 1%. The deviation of the moisture weight content ratio again from the critical range can be prevented effectively by putting the moisture weight content ratio into the critical range.

In another embodiment, the moisture weight content ratio can be adjusted to be a arbitrary value within criteria. For example, the moisture weight content ratio can be adjusted to be arbitrary values such as 0, −1.8, and 0.7 within criteria when the critical range in first period is between −2% and 1% and the current moisture weight content ratio is 2%.

The nutrient solution unit and server in the irrigation management system can be realized in all-in-one type. In this case, the all-in-one type unit calculates the moisture weight content ratio based on the weight value received from the weight sensor, generates control signal and controls the irrigation to the medium. The mechanism of calculating, controlling signal and irrigation is not explained again because it is same as the irrigation management system type equipped with separate nutrient solution unit and server.

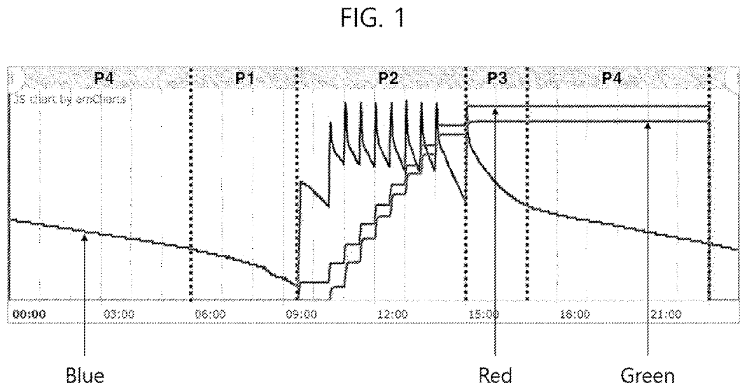

FIG. 1 depicts the supply and drainage to the medium, changes on weight of the medium.

Respective moisture weight content ratio can be calculated from the FIG. 1.

24 hours can be divided into total 4 periods by referring to FIG. 1. Wherein the first period (P1) is between 06:00 and 09:00, second period (P2) is between 09:00 and 15:00, third period is between (P3) 15:00 and 17:00 and fourth period (P4) can be between 17:00 and 06:00 (On the coming day).

Here, the critical range of the moisture weight content ratio can be between −2% and 1% in first period, 6% and 8% in second period, −4% and 3% in third period and −3% and −2% in fourth period.

The critical range of each period can be set differently depending on the types and cultivating conditions (For example, growth period, blooming period and harvesting period) of the crops.

Precise moisture weight content ratio can be obtained for each period by measuring the weight by means of weight sensor at the starting and ending point on each period.

In FIG. 1, the blue line represents the weight value (kg) of the medium, the red line represents the irrigation value (cc) and the green line represent drainage value (cc). In an aspect of time, the irrigation begins first, and after a while, the drainage begins. The irrigation value is bigger than the drainage value in each time. The weight value increases and decreases repeatedly after increasing at the starting point in second period, and decreases consistently to the ending point in first period through fourth period. The weight value repeats increase and decrease in an uniform pattern from a certain moment while increasing after beginning the irrigation. The weight value decreases gradually when the irrigation stops. The amount of irrigation and drainage represents a pattern increasing gradually in steps. when beginning the irrigation.

The following <Production Quantity 1 and 2> displays the changes on the amount of strawberry yield before and after using the irrigation management system of this invention.

<Production Quantity 1>
Production
Total

| Box(5 kg) | Kg |
|---|---|
| 15 | 75 |
| 10 | 50 |
| 20 | 100 |
| 18 | 90 |
| 7 | 35 |
| 2 | 10 |
| 5 | 25 |
| 20 | 100 |
| 19 | 95 |
| 26 | 130 |
| 16 | 80 |
| 18 | 90 |
| 15 | 75 |
| 20 | 100 |

Displays the yield before using the irrigation management system.
Production Year: 2020
Distribution Period: January-April 2020
Total Production Quantity: 1,055 kg

<Production Quantity 2>
Production
Total

| Box(5 kg) | Kg |
|---|---|
| 20 | 100 |
| 15 | 75 |
| 19 | 95 |
| 21 | 105 |
| 14 | 70 |
| 12 | 60 |
| 18 | 90 |
| 16 | 80 |
| 15 | 75 |
| 25 | 125 |
| 19 | 95 |
| 15 | 75 |
| 18 | 90 |
| 20 | 100 |

Displays the yield after using the irrigation management system.
Production Year: 2021 Distribution Period: January-April 2021
Total Production Quantity: 1,235 kg

The following <Production Quantity 3 and 4> displays the changes on the amount of paprika yield before and after using the irrigation management system in of this invention.

<Production Quantity 3>
Production
Total

| Box(5 kg) | Kg |
|---|---|
| 15 | 75 |
| 10 | 50 |
| 20 | 100 |
| 18 | 90 |
| 7 | 35 |
| 2 | 10 |
| 5 | 25 |
| 20 | 100 |
| 19 | 95 |
| 26 | 130 |
| 16 | 80 |
| 18 | 90 |
| 15 | 75 |
| 18 | 90 |
| 10 | 50 |
| 18 | 90 |
| 19 | 95 |
| 15 | 75 |
| 20 | 100 |

Displays the yield before using the irrigation management system.
Production Year: 2020
Distribution Period: January-June 2020
Total Production Quantity: 1,455 kg

<Production Quantity 4>
Production
Total

| Box(5 kg) | Kg |
|---|---|
| 20 | 100 |
| 15 | 75 |
| 19 | 95 |
| 21 | 105 |
| 14 | 70 |
| 12 | 60 |
| 18 | 90 |
| 16 | 80 |
| 15 | 75 |
| 25 | 125 |
| 19 | 95 |
| 15 | 75 |
| 18 | 90 |
| 20 | 100 |
| 18 | 90 |
| 24 | 120 |
| 25 | 125 |
| 22 | 110 |

Displays the yield after using the irrigation management system.
Production Year: 2021
Distribution Period: January-June 2021
Total Production Quantity: 1,680 kg

Not shown, the irrigation management system in this application can prevent the excessive supply of the nutrient solution. The irrigation management system may further comprise concentration sensor and/or acidity sensor. The nutrient solution is stored into the nutrient solution unit after mixing by the agitator. The concentration sensor and/or acidity sensor measures the nutrient solution emitted from the nutrient solution unit, and stops irrigation and controls the concentration and oxygen when the concentration is measured approximately in 10-15% not influential to the harvesting amount of the crops by measuring the nutrient solution from the nutrient solution unit. Next, it washes the nutrient solution remained on the irrigational by using fresh water. By means of this, the supply of nutrient solution in excessive concentration and acidity can be prevented.

Not shown, the irrigation management system in this application can adjust the irrigation by changing concentration on nutrient solution. For example, the irrigation management system can adjust the moisture weight content ratio to stay within the critical range by changing the composition on the concentration of the nutrient solution when the moisture weight content ratio measured by the weight sensor is out of the critical range. In addition, the irrigation management system can adjust the timing and rate of nutrient solution injection.

Even though the above exemplary embodiments were described with the limited embodiments and drawings as in the above, various corrections and transformations are available from the above descriptions for the people who have usual knowledge on the corresponding arts. For example, the appropriate results can be achieved even though the described arts are performed in different sequence with the described procedures, and/or the components like the describe system, structure, device and circuit are combined or assembled in different format with the described procedures, alternated or substituted with other components and equivalents.

Accordingly, other realizations, other embodiments and equivalents ones applied for patent belong to what is claimed is described later.

1. An irrigation management system for nutriculture of the crops, the irrigation management system comprising:
a medium;
a weight sensor;
a nutrient solution unit; and
a server, wherein
the weight sensor measures weight of the medium and transmits weight value to the server;
the server calculates moisture weight content ratio based on the weight value, generates a control signal based on the moisture weight content ratio, and transmits the control signal to the nutrient solution unit;
the nutrient solution unit controls irrigation to the medium based on the control signal;
the weight value is measured at respective starting and ending point in the plurality of periods dividing 24 hours by the pre-determined criteria, and
the plurality of periods respectively have a moisture weight content ratio, and
each moisture weight content ratio is derived according to the following formula:
$$Ww = ( Wo - W ) / W * 100$$
wherein
Ww is the moisture weight content ratio, Wo is the weight at ending point of each period, and W is the weight at starting point of each period,
the control signal includes irrigation increment signal when the moisture weight content ratio of each period is less than critical range of each period,
the control signal includes irrigation decrement signal when the moisture weight content ratio of each period is more than critical range of each period,
the nutrient solution unit either increases the amount of irrigation to the medium or shortens irrigation cycle when the control signal includes the irrigation increment signal, and
the nutrient solution unit either decrease the amount of irrigation to the medium or extends the irrigation cycle when the control signal includes the irrigation decrement signal,
wherein the moisture weight content ratio is adjusted based on the pattern of the moisture weight content ratio,
the server analyze the fluctuation pattern on the moisture weight content ratio as increment when moisture weight content ratio increases more than the pre-determined times during the pre-determined monitoring time, the server adjust the moisture weight content ratio to be the farthest value within the critical range from the moisture weight content ratio when the moisture weight content ratio is more than the critical range within the pre-determined time from the resulting time of the analysis,
the server analyze the fluctuation pattern on the moisture weight content ratio as decrement when moisture weight content ratio decreases more than the pre-determined times during the pre-determined monitoring time, the server adjust the moisture weight content ratio to be the farthest val e within the critical range from the moisture weight content ratio when the moisture weight content ratio is less than the critical range within the pre-determined time from the resulting time of the analysis.

2. The system according to claim 1, wherein
the plurality of periods include first period to fourth period,
the starting point of the first period is sunrise time, the ending point is the first irrigation time, the critical range is between −2% and 1%,
the starting point of the second period is the first irrigation time, the ending point is the final irrigation time, the critical range is between 6% and 8%,
the starting point of the third period is the final irrigation time, the ending point is sunset time, critical range is between −4% and 3%, and
the starting point of the fourth period is sunset time, the ending point is sunrise time and critical range is between −3% and 2%.

3. (canceled)

4. An irrigation management system for nutriculture of the crops, the irrigation management system comprising:
a medium;
a weight sensor; and
a nutrient solution unit, wherein
the weight sensor measures weight of the medium and transmits weight value to the nutrient solution unit;
the nutrient solution unit calculates moisture weight content ratio, and generates a control signal based on the moisture weight content ratio, and controls the irrigation to the medium based on the control signal,
the weight value is measured at respective starting and ending point in the plurality of periods dividing 24 hours by the pre-determined criteria, and
the plurality of periods respectively have a moisture weight content ratio,
each moisture weight content ratio is derived according to the following formula:
$$Ww = ( Wo - W ) / W * 100$$
wherein
Ww is the moisture weight content ratio, Wo is the weight at ending point of each period, and W is the weight at starting point of each period,
the control signal includes irrigation increment signal when the moisture weight content ratio of each period is less than critical range of each period,
the control signal includes irrigation decrement signal when the moisture weight content ratio is more than critical range,
the nutrient solution unit either increases the amount of irrigation to the medium or shortens irrigation cycle when the control signal includes the irrigation increment signal, and
the nutrient solution unit either decreases the irrigation amount to the medium or extends the irrigation cycle when the control signal includes the irrigation decrement signal,
the server analyze the fluctuation pattern on the moisture weight content ratio as increment when moisture weight content ratio increases more than the pre-determined times during the pre-determined monitoring time, the server adjust the moisture weight content ratio to be the farthest value within the critical range from the moisture weight content ratio when the moisture weight content ratio is more than the critical range within the pre-determined time from the resulting time of the analysis,
the server analyze the fluctuation pattern on the moisture weight content ratio as decrement when moisture weight content ratio decreases more than the pre-determined times during the pre-determined monitoring time, the server adjust the moisture weight content ratio to be the farthest val e within the critical range from the moisture weight content ratio when the moisture weight content ratio is less than the critical range within the pre-determined time from the resulting time of the analysis.

5. The system according to claim 4, wherein
the plurality of periods include first period to fourth period,
the starting point of the first period is sunrise time, the ending point is the first irrigation time, the critical range is between −2% and 1%,
the starting point of the second period is the first irrigation time, the ending point is the final irrigation time, the critical range is between 6% and 8%,
the starting point of the third period is the final irrigation time, the ending point is sunset time, critical range is between −4% and 3%, and
the starting point of the fourth period is sunset time, the ending point is sunrise time and critical range is between −3% and 2%.

6. (canceled)
